(19) United States
(12) Patent Application Publication
(10) Pub. No.: US 2009/0001706 A1
(43) Pub. Date: Jan. 1, 2009

(54) SELF-ADHESIVE MESSAGE PANEL

(76) Inventor: W. Rene Huber, Upper Saddle River, NJ (US)

Correspondence Address: CASELLA & HESPOS, 274 MADISON AVENUE, NEW YORK, NY, 10016, US

(21) Appl. No.: 12/146,001

(22) Filed: Jun. 25, 2008

Related U.S. Application Data
(60) Provisional application No. 60/937,620, filed on Jun. 28, 2007.

(51) Int. Cl. B42D 17/00; B32B 38/10

(52) U.S. Cl. 281/44; 156/191

(57) ABSTRACT

A message panel assembly includes a flexible message sheet having a front surface that exhibits writable and erasable characteristics. The rear surface of the message sheet is at least partly coated with a removable adhesive. A strip or flap can be cut in the message sheet and can be secured around a cap of a writing implement. Thus, the writing implement can be separated from both the cap and the message sheet. The adhesive backed message sheet can be removably secured to a door, wall or other support surface so that the writing implement can be used to leave messages on the front surface of the message sheet.

This application claims priority on U.S. Provisional Patent Appl. No. 60/937,620, filed Jun. 28, 2007.

### BACKGROUND OF THE INVENTION

1. Field of the Invention

The invention relates to a printable, variable die cuttable writable, erasable laminate that can be mounted releasably to a surface for posting temporary messages/information and for securing a writing instrument.

2. Description of the Related Art

Active lifestyles of many people frequently require temporary messaging for persons who cannot be accessed directly. Messages of these types are common at homes, work places and schools. Additionally, supporting documents, pictures or other materials may occasionally accompany the notes.

Temporary messages are key components of communication on most college campuses. Scheduling, information and social content between one student and another is virtually continuous. Study, work and social routines frequently change and need coordination. The dormitory room is a place for sleeping, changing clothes and occasional studying. The dormitory door frequently is a focal point at which students coordinate their activities, itineraries and group study efforts, and social agendas.

Most college campuses recognize the importance of inter-student communications and the intricacies of those communications that are created by the unique lifestyles of college students. As a result, most college dorm rooms provide or permit message boards on the dorm room doors. The message boards used on college dorm rooms take many forms, and include bulletin boards, chalk boards and panels that have an erasable surface. Some message boards may use tape, pushpins and the like.

All of these dorm-room message boards include a substrate and/or a frame, both of which are of considerable dimension and mass. A typical bulletin board, blackboard or dry erase/erasable panel will be at least one half inch thick. These known message boards require mounting hardware or separate adhesive members of sufficient strength to hold the message board on the door or on a section of a hall wall adjacent the door. Screws, nails, pushpins, and other mounting hardware invariably will damage the door or wall to which the message board is mounted. Additionally, mounting hardware may impose a cost penalty on the message board and requires additional time for proper installation and repair. Adhesive strips also create cost penalties and mounting penalties, as well as periodic replacement or repair. An adhesive strip that is sufficiently strong to support a message board is also likely to damage the door or wall surface and the adhesive used cannot be sustained for rehanging if necessary.

Message boards also require a means for creating and leaving the message. For example, a bulletin board requires a supply of message slips, pushpins and at least one writing implement. These necessary appurtenances must be stored on or near the bulletin board. Storage means for any of these appurtenances complicates and compromises bulletin board functionality use, can add cost and defeat a tidy environment with littered and lost components. Furthermore, push pins and nails, or loose writing implements can create a hazard when dislodged from the bulletin board.

Blackboards have many of the same problems as bulletin boards, and typically are much heavier. Blackboards also require structures for maintaining supplies of chalk and at least one eraser, and as such are not a preferred messaging mechanism.

Erasable writing panels have some advantages over bulletin boards and blackboards. However, the prior art erasable writing panels suffer from the above-described problems of size, weight and mounting difficulties. Furthermore, most erasable writing panels are suited for only particular types of felt-tip markers that should be stored near the panel. As a result, an appropriate erasable writing panel is likely to have a small shelf for writing implements, a self contained clip, or a cord from which a writing implement may be suspended. A pen clip for an erasable writing panel would be attached to the frame of the panel and is designed for only one size or style of pen. All of these options add to the cost, increase complexity and prevent universality of the message board.

Homes and workplaces have many of the same messaging problems as a college dormitory. Children, parents and coworkers frequently use message boards or scraps of paper to leave messages for one another.

The preceding discussion has focused on inefficiencies and shortcomings for the user of a prior art message board. Similar inefficiencies exist for retailers of the prior art message board. In particular, the bulky massive message boards require considerable retail space in college book stores, stationery stores, drug stores, home supply stores and the like. Some retailers, such as supermarkets and gift shops resist carrying bulky message boards due to critical space limitations.

People in college dormitories, homes and offices are frequent customers of service related businesses and particularly food-related businesses. Restaurants and convenience food stores frequently make deliveries to college dormitories, homes and offices. Restaurants and other food related businesses rely upon customers having telephone numbers, fax numbers or email addresses conveniently accessible for placing an order. The same is true for pharmacies, banks, and countless other service and supply businesses. Most college dormitories have large message boards in public spaces and those message boards are covered with advertisements from pizza shops, fast food restaurants and the like. Many such businesses spend large amounts of money for advertisements in school and local newspapers. Restaurants remote from college campuses or towns spend considerable amounts of money on various forms of advertising and promotion including widespread distribution of menus, magnetic business cards, handouts and the like.

In view of the above, it is an object of the invention to provide improved options for leaving temporary messages at schools, homes, offices, locker room, production sites, military facilities such as on board ships, recreational facilities, hospitals and other locations.

It is another object of the invention to provide a messaging option that reduces storage space for retailers that currently sell prior art message boards.

A further object of the invention is to provide a convenient mechanism for businesses to disseminate marketing information via printable content.

Yet another object of the invention is to provide an erasable writing panel that can be mounted indefinitely to virtually any surface without damaging the surface upon while remaining mounted or upon removal.

### SUMMARY OF THE INVENTION

The invention relates to a lightweight flexible message panel. The message panel includes at least one message sheet that has opposite front and rear surfaces. The front surface of the message sheet is a writable and erasable surface so that written messages repeatedly can be inscribed on and then removed from the front surface of the message sheet by wiping with any material, such as tissue, cloth, paper or even a finger.

The message sheet may be formed from a single layer of a lightweight flexible durable material, such as polypropylene or polyester. Alternatively, the message sheet can be a laminated sheet assembly with a substrate and a top layer. The substrate may be selected to provide sufficient structural integrity and support, while also providing a low cost. For example, the substrate may be paper or an inexpensive filmic material. The top layer is a material that exhibits the required writable/erasable characteristics while allowing any underlying graphics or material characteristics to be evident. More particularly, the top layer may include an appropriate coating to provide the erasabilty, while also exhibiting the required strength.

The rear face of the message sheet is coated with an adhesive that exhibits clean release characteristics. Thus, the adhesive selected will hold the message sheet securely on a vertical support surface for an extended and virtually indefinite period of time. However, the adhesive also is selected to enable the message sheet to be removed from the support surface without any trace footprint or damage to the support surface and without leaving residue after the message sheet has been removed. These characteristics apply to all available surfaces including, but not limited to, wall coverings, glass, wood, plastics, metals papers, rigid fabrics, painted surfaces, stone and tile

The adhesive also preferably is selected so that the message sheet can be repositioned and reapplied to the support surface a plurality of times if desired. Adhesives of this type often are referred to commercially as temporary/permanent. The adhesive preferably is applied across the entire rear surface of the message sheet, but may be coated partially or coated with a pattern to achieve a particular grip specification depending upon the characteristics of the sheet and the intended support surface. The rear surface of the message sheet also may be precoated before applying the adhesive, depending upon the characteristics of the material from which the message sheet is formed and depending upon the desired adhesive characteristics. For example, a message sheet that includes a substrate formed from a film may be more likely to require a pre-coating than a message sheet formed from a paper substrate. Coating materials with these characteristics are known to those skilled in the art and will be selected in accordance with the material chosen for the message sheet and the adhesive. A removable backing sheet preferably is applied over the adhesive to ensure that the adhesive characteristics retain their specifications until the message sheet is intended to be peeled away and attached to a support surface.

Additionally, the removable backing sheet, also known as the liner, is processed so as to be printable so that use instructions, cautions, advertising, coupons, or other indicia may be supplied as desired within the one construction. In such a configuration information included may be retained by the user for a multitude of purposes.

The front surface of the message sheet may be colored, tinted or provided with permanent indicia thereon. The coloring, tinting or permanent indicia may be provided directly on the front surface or may be provided to be visible from the front surface through a clear film lamination. For example, coloration, tinting or permanent indicia can be provided on a substrate and a substantially clear or tinted top layer that is writable and erasable may be provided over the substrate so that the coloration, tinting or printing on the substrate is protected yet visible. The coloration, tinting or the like can be provided for aesthetic or economic reasons. Permanent printed indicia can be provided to convey certain messages that may be relevant to the person who owns the message panel or the people who use the message panel. For example, peripheral regions of the front surface of the message sheet may be imprinted with certain advertising indicia such as the telephone number, fax number or email address of a local retail facility. In other situations, the permanent indicia may be an athletic schedule or logo, a calendar or a listing of emergency telephone numbers. Preferably, however, a major portion of the front surface of the message sheet is available for the clear but temporary placement of erasable messages. Thus, permanent indicia may be disposed in top, bottom or side margins of the message sheet, whereas more central portions of the front surface are available for providing erasable messages.

As described above, tinting, coloration or permanent indicia may be provided on the message sheet or alternatively beneath the message sheet. In other embodiments, tinting, coloration or permanent indicia may be provided on a partial outer sheet applied to the front surface of the message sheet. For example, the partial outer sheet may be a decorative material, such as foil or holographics, and can be applied to areas of the front surface of the message sheet other than those areas to which the messages themselves are intended to be applied.

The message panel assembly preferably includes means for releasably holding a writing implement. For example, one or more cuts may extend into a peripheral region of the message panel. The area of the message panel defined by the one or more cuts can be folded or wrapped around the cap of a pen, marker or other such writing implement. Thus, the cap is held securely adjacent a peripheral region of the message panel. The pen associated with the cap can be removed from and replaced back in the cap while the cap is held securely adjacent to the message panel. As a result, a user can remove the pen from the cap that is secured adjacent to the message panel. The pen can be used to write a message and then can be placed back in the cap for storage until it is necessary to write another message. This included construction ensures a firm grip on the cap itself and directs the writer to return the pen body back into its cap for proper ink preservation. This format also ensures that the pen will remain attached to the message panel assembly and not be separated and lost, as with other message board assemblies.

Alternatively, the writing instrument may be secured to the message panel by two in-line die-cut holes in the message panel at positions one above the other. This part of the message panel then can be folded and secured in face-to-face relationship near the fold with the holes aligned vertically. Thus, the pen can be positioned securely in the holes. The pen also can be removed, used and replaced, thereby allowing the user to remove, exchange or replace the entire writing instrument, as desired.

The pen need not be attached to the message panel at the time of sale and may be attached by the user as later instructed. As a result, the message panels can be stored in a very compact stack or possibly on a roll after manufacture, during shipment or storage at a finishing facility for subsequent processing by third parties. The purchaser or other such recipient of the message panel can then attach the writing implement to the message panel shortly before or after releasably attaching the message panel to a support surface. The writing implement may be sold attached to the panel at the time of manufacture or otherwise provided concurrently with the message panel.

Often it is desirable to accompany a written message with a specific attachment, such as a map, tickets to an event, instructions or a multitude of accompanying items. Therefore, because the message board is constructed with a repositionable adhesive, a liftable flap may be provided near the bottom of the panel to hold such attachments with the same repositionable adhesive. Such a flap will facilitate the delivery of such items because they can readily be attached and held under the flap and then subsequently can be retrieved in connection with the message.

### BRIEF DESCRIPTION OF THE DRAWINGS

FIG. 1 is a front elevational view of a message panel assembly in accordance with the invention.

FIG. 2 is a side elevational view of the message panel assembly shown in FIG. 1.

FIG. 3 is a cross-sectional view taken along line 3-3 in FIG. 1.

FIG. 4 is a front elevational view of the message panel assembly with a writing implement attached thereto.

FIG. 5 is a side elevational view of the message panel assembly shown in the FIG. 4 condition.

FIG. 6 is an exploded front elevational view showing the writing implement being separated from the cap and the message panel assembly.

FIG. 7 is a cross-sectional view similar to FIG. 3, but showing an alternate embodiment.

FIG. 8 is a cross-sectional view of a third embodiment.

FIG. 9 is a front elevational view of a fourth embodiment of a message panel assembly in accordance with the invention including a pen mount for holding a pen in a vertical orientation.

FIG. 10 is a front elevational view of the message panel assembly of FIG. 9 showing the pen mount in a fully assembled condition and with the pen mounted therein.

FIG. 11 is a side elevational view of the message panel assembly shown in FIG. 10.

### DETAILED DESCRIPTION OF THE PREFERRED EMBODIMENTS

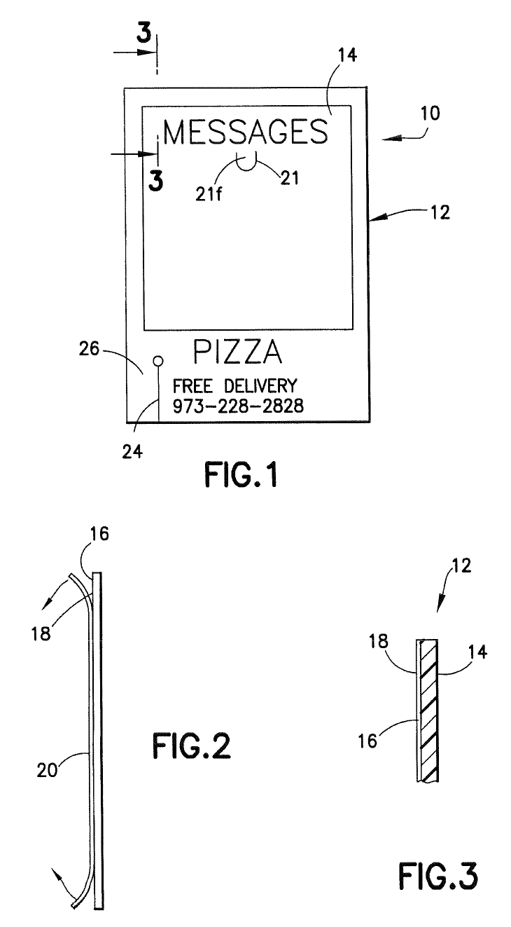

A message panel assembly in accordance with a first embodiment of the subject invention is identified generally by the numeral 10 in FIGS. 1-6. The message panel assembly 10 includes a message sheet 12 having a front surface 14 and an opposite rear surface 16. In the embodiment shown in FIGS. 1-6, the message sheet 12 is a single sheet of a material, such as polypropylene, that exhibits good writable and erasable characteristics at least on the front surface 14 thereof. A layer of adhesive 18 is applied to the rear surface 16 of the message sheet 12. The adhesive is selected to provide good long term adhesion. However, the adhesive also must be removable and repositionable without damaging the supporting surface and without leaving residue on the supporting surface while at the same time be capable of aggressively holding the pen cap in place during repeated use. A microspherical repositionable adhesive or a removable adhesive are examples of those types of adhesives that work well. One repositionable adhesive that has been found suitable for many applications is the T1055 adhesive available from Nastar, Inc of Middletown, Wis. The adhesive preferably is selected so that the bond between the adhesive 18 and the rear surface of the message panel 12 is stronger than the bond between the adhesive and the support surface.

The above-described adhesive must safely support the mounting of the panel described and allow for a clean, residue-free, non-damaging removal. However, the adhesive also must be such that when bonded to itself, it forms an aggressive, semi-permanent hold or bond to the pen cap it embraces when adhesive is pressed to adhesive. Furthermore, the adhesive should remove cleanly and residue-free from most surfaces even after extended periods of adhesion.

The panel assembly 10 further includes a release liner 20 secured to the adhesive 18 on the rear surface 16 of the message sheet 12. The release liner 20 is formed from or coated with a material, such as silicone, that can be separated from the message sheet 12 a silicon coated material that allows separation from the adhesive 18. The release liner 20 typically will be separated from the message sheet 12 by the consumer shortly prior to releasably mounting the message sheet 12 to a door D or other such support surface.

The message sheet 12 is configured so that indicia is permanently presented on the front surface 14 or is visible from the front surface 14 as explained in other embodiments described herein. The indicia preferably are near the bottom edge of the message sheet 12 and/or near the top edge thereof. The indicia may be advertising information, including contact information for the advertiser. Alternatively, the information permanently imprinted on the message sheet 12 may be a calendar or public service telephone numbers; sport or college logos; websites; or countless other indicia.

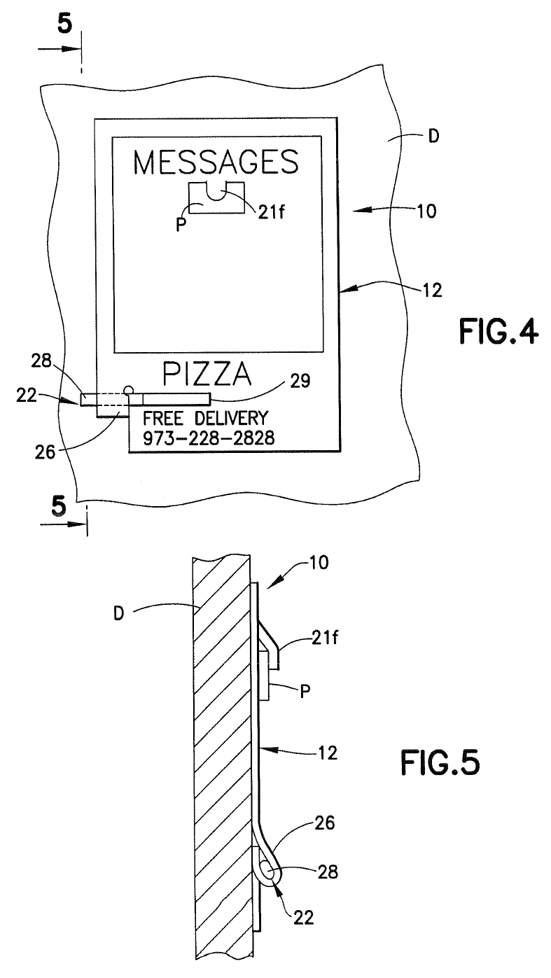

At least one U-shaped cut 21 is formed in the message sheet 12 to define an adhesive backed flap 21f that can be used to hold a picture, note or the like, as identified generally by the letter P in FIGS. 4 and 5. The cut 21 and flap 21f of course can be at other locations.

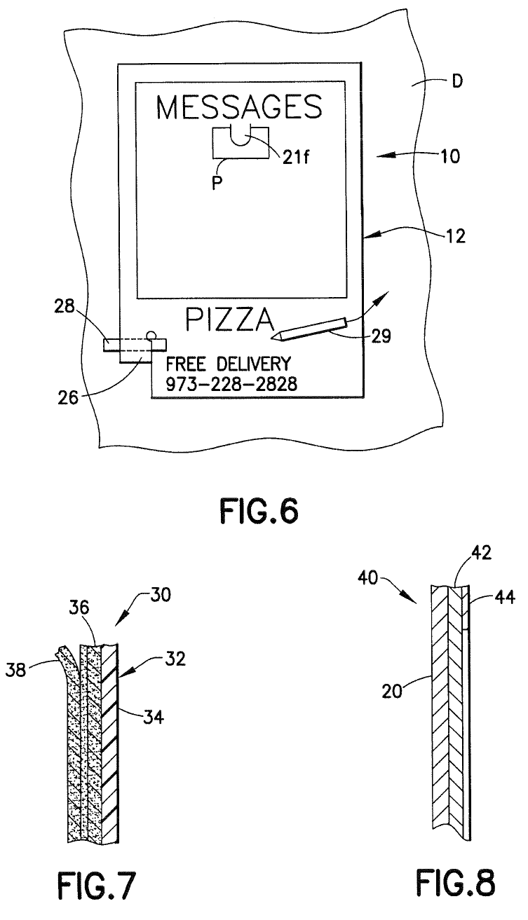

The message panel assembly 10 preferably includes at least one writing implement and preferably is provided with means for holding the writing implement 22. As shown in FIG. 1, a vertical cut 24 is formed to extend up from the lower edge of the message panel assembly. Instructions may be imprinted on the message sheet in proximity to the cut 20 so that the purchaser or recipient of the message panel assembly 10 will be instructed to remove the release liner 20 at least locally on the area adjacent the cut 24. The adhesive backed strip 26 defined by the cut 24 then can be wrapped securely around the cap 28 of the writing implement 22, as shown most clearly in FIGS. 4 and 5. The indicia on the front surface 14 of the message sheet 12 can include indicia to identify and guide the preferred position and alignment of the writing implement 22. As a result, as shown most clearly in FIG. 4, the entire writing implement 22 is held securely by wrapping the strip 26 around the cap 28 of the writing implement 22. The body 29 of the writing implement 22 then can be separated from the cap 28, as shown in FIG. 6, so that the body 29 of the writing implement 22 can be used to write an appropriate message on the front surface 14 of the message sheet 12. The body 29 of the writing implement 22 can be telescoped back into the cap 28 when the message has been written for storage and ink preservation.

FIG. 7 shows an alternate embodiment of a message panel assembly 30 with a message sheet 32 that is a laminated subassembly. More particularly, the message sheet 32 includes a top layer 34 and a substrate 36 permanently laminated to the top layer 34. The above-described adhesive is applied over a surface of the substrate 36 facing away from the top layer 34. A release liner 38 is attached removably to the rear surface of the substrate 34. With this embodiment, the top layer 34 can be thinner than in the first embodiment and the required structural integrity can be provided at least partly by a less expensive substrate 36. The top layer 34 may be formed from a transparent or tinted material. The substrate 36 then may be colored and/or imprinted with appropriate indicia, including advertising information and/or contact information.

FIG. 8 shows a third embodiment of a message panel assembly 40 with a message sheet 42. The message sheet 42 may be a single layer as in the first embodiment or a laminated subassembly as in the second embodiment. However, the message panel assembly 40 of the third embodiment further includes a top layer of foil or the like applied at least locally over the front surface of the message sheet 42. In this illustrated embodiment, the foil layer 44 extends around peripheral regions of the message sheet 42.

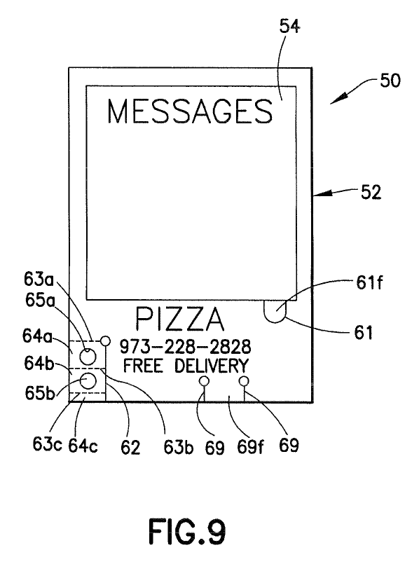

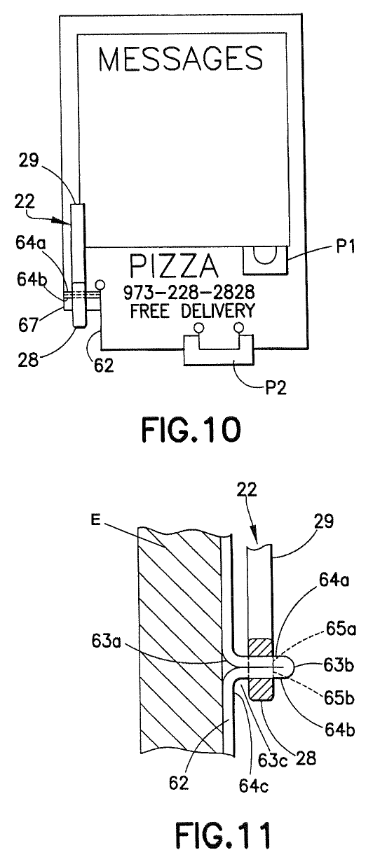

FIG. 9 shows a fourth embodiment of a message panel assembly 50 with a message sheet 52. The message sheet 52 is similar to the message sheet 12 described and illustrated above and includes a front surface 54 that exhibits good writable and erasable characteristics. The message panel assembly 50 differs from the message panel assembly 10 in a few respects. Specifically, the message panel assembly 10 includes a U-shaped cut 21 in the message sheet 12 to define an adhesive backed flap 21f that can be used to hold a picture, note or the like as identified generally by the letter P in FIGS. 4 and 5. However, the message panel assembly 50 shown in FIGS. 9 and 10 includes a similar U-shaped cut 61 at a location below the area of the message sheet 52 that is intended to receive the writable and erasable messages. As a result, a larger area of the message sheet 52 can be devoted to written messages. As a further variation, the message sheet 52 shown in FIG. 9 includes two parallel slits 69 adjacent the bottom edge to define a flap 69f. The flap 69f can be rotated away from the door D or other support on which the message panel assembly 50 is mounted and a card, note, photograph or the like can be positioned in proximity to the flap 69f. The flap 69f then is rotated back for securely, but releasably, holding the picture P, card, note or the like P in position. Other locations for an adhesive flap to hold pictures P, cards, notes or the like can be positioned at other locations and can have other configurations.

The message panel assembly 50 also has a different configuration for holding a writing implement. In this regard, an elongate slit 62 extends vertically up from the bottom edge of the message sheet 52 substantially parallel to and near the left side edge in FIG. 9. Upper, middle and lower fold lines 63a, 63b and 63c extend perpendicularly from the slit 62 to the left side edge of the message sheet 52. The upper fold line 63a is farthest from the bottom edge of the message sheet 52 and the lower fold line 63c is closest to the bottom edge of the message sheet 52. The fold lines 63a, 63b, 63c may be printed on the message sheet 52 or may be defined at least partly by scores in the message sheet 52. A top pen support panel 64a is defined between the upper fold line 63a and the middle fold line 63b. A lower pen support panel 64b is defined between the intermediate fold line 63b and the lower fold line 63c. The pen support panels 64a and 64b define substantially identical rectangles and preferably are approximately square. A support tab 64c is defined between the lower fold line 63c and the lower edge of the message sheet 52. An upper pen support aperture 65a is formed through the upper end support panel 64a and a lower pen support aperture 65b is formed through the lower end support panel 64b. The apertures 65a and 65b define substantially identical circles and are vertically aligned with one another.

The message sheet 52 can be mounted on a door, wall or other vertical support in substantially the same manner as the message sheet 12 described and illustrated above. However, the pen support is configured differently. In this regard, the upper pen support panel 64a is rotated about the upper fold line 63a. The lower pen support panel then is rotated about the middle fold line 63b so that the rear face of the lower pen support panel 64b is secured in face-to-face engagement with the upper pen support panel 64a. The tab 64c then is secured to the door D, wall or other such support so that the upper and lower pen support panels 64a and 64b project substantially perpendicularly outwardly from the door D with the pen support apertures 65a and 65b substantially registered with one another. The apertures 65a and 65b are dimensioned to tightly receive the cap 28 of the pen 22 so that the pen body projects upwardly from the cap 28. The body 29 of the pen 22 can be separated from the cap 28 to write a message and then can be returned to the cap 28 upon completion of the message.

While the invention has been described with respect to certain preferred embodiments, it is apparent that various changes can be made without departing from the scope of the invention. For example, the message panel assembly can take configurations other than the rectangular shape shown in the attached figures such as a shield.

The preferred embodiment shows a writing implement attached to a lower area of the message panel assembly adjacent to one lateral edge. However, two parallel cuts can be provided in the message panel assembly and the writing implement can be affixed at a more central position. In other embodiments, plural writing implements can be attached allowing for the use of multiple colors in the message panel presentation.

The message panel assembly can be packaged as a stack of separate message panel assemblies that are removed sequentially from the pack. Alternatively, an array of message panel assemblies can be stored in a roll form and can be dispensed sequentially from the roll. In this optional embodiment, perforation arrays will separate adjacent message panel assemblies on the roll and can be separated from one another by a user or customer.

The optionally included flap, employing the same clean-release adhesive of the base panel, envisions the ability to securely, but releasably hold objects and papers that may often be related to the message posted on the panel.

Because the removable backing of the panel can be printed with indicia, instructions for use, coupons, advertisement, or other information, it is inherently incorporated into one piece making up the panel. This flexibility allows for information connection between the panel proper and the separatable backing or liner which is able to be retained if desired.

The structure for receiving and supporting the pen can be oriented differently. For example, the slit 24 of the first embodiment can extend horizontally so that a loop can be formed by the strip to support a pen vertically. Similarly, the slit 62 shown in FIG. 9 can extend horizontally so that a pen can be supported horizontally.

What is claimed is:

1. A message panel assembly comprising a message sheet having opposite front and rear surfaces, the front surface of the message sheet being formed from a material that exhibits writable and erasable characteristics, a clean release removable adhesive being applied to the rear surface of the message sheet and a release layer removably applied over adhesive, a writing implement being attachable in proximity to the message sheet so that a portion of the writing implement is selectively removable from the message sheet for writing a message on the front surface of the message sheet.

2. The message panel assembly of claim 1, wherein the message sheet includes a top layer and a substrate, the adhesive being applied to the substrate.

3. The message panel assembly of claim 2, wherein the substrate is paper.

4. The message panel assembly of claim 1, wherein the message sheet includes an adhesive backed strip formed by at least one cut extending into a peripheral edge of the message sheet, the adhesive backed strip being engageable around a cap of the writing implement.

5. The message panel assembly of claim 1, further comprising permanent indicia printed at selected locations that are visible from the front surface of the message sheet.

6. A method for mounting a message panel assembly on a support surface, the method comprising:
providing a flexible message sheet having a front surface that exhibits writable and erasable characteristics and a rear surface coated at least partly with a removable adhesive, a release liner covering the removable adhesive;
removing the release liner from a strip of the message sheet;
wrapping the strip around a cap of a writing implement so that the adhesive engages the cap and so that a writing portion of the writing implement is not secured by the adhesive;
removing remaining parts of the release liner from the message sheet; and
securing the rear surface of the message sheet to the support surface.
